(19) United States
(12) Patent Application Publication
(10) Pub. No.: US 2008/0280132 A1
(43) Pub. Date: Nov. 13, 2008

(54) Thick Insulation Band

(75) Inventor: Martin Deib, Abtsgmund (DE)

Correspondence Address: JANSSON SHUPE & MUNGER LTD., 245 MAIN STREET, RACINE, WI, 53403, US

(73) Assignee: ISO-CHEMIE GBMH, Aalen (DE)

(21) Appl. No.: 12/116,033

(22) Filed: May 6, 2008

(30) Foreign Application Priority Data
May 11, 2007 (EP) 07 009 468.5

(51) Int. Cl. B32B 7/12

(52) U.S. Cl. 428/332; 428/343

(57) ABSTRACT

The insulating tape has a backing layer, which has two opposite sides, and segments of an insulating layer of rigid insulation material, which are attached adhesively to the first side of the backing layer. The segments of the insulating layer are separated from each other by incisions arranged a predetermined intervals and are connected to each other by the backing layer. The backing layer has a self-adhesive property on the second side.

### CROSS REFERENCE TO RELATED APPLICATION

This application claims priority based on European patent application EP 07 009 468.5, filed May 11, 2007.

### FIELD OF THE INVENTION

This invention pertains to the field of insulating tapes of the type with an insulating layer of hard insulation material.

### BACKGROUND OF THE INVENTION

These types of insulating tapes have an insulating layer which is usually attached to a backing layer. Such tapes are used in particular for thermal separation in various installation situations involving trapezoidally corrugated sheet construction, sandwich-type construction, and metal construction. A special area of application is the prevention of cold bridges between building substructures and external shells. They can be used both in walls and in roofs. It is important for such tape to have high compressive strength and to be easy to work with.

As a result of continuously increasing requirements on insulation values with the goal of achieving even lower degrees of heat conduction, these types of insulating tapes must be made thicker to perform their function properly. It is a problem here that strips of thermal-separation insulating tapes which are too thick can no longer be wound up into rolls.

### SUMMARY OF THE INVENTION

It is an object of the present invention to create an insulating tape for thermal separation in the construction industry which achieves high insulating values and can also be stored and transported in a space-saving fashion.

According to an embodiment of the invention, the insulating tape has an insulating layer of hard insulating material into which incisions have been made at predetermined intervals. The individual segments of the insulating layer are formed between the incisions and remain connected to each other. On the side facing away from the insulating layer, the backing layer has self-adhesive properties. The segments are bonded adhesively to the backing layer.

In this case, the backing layer can be provided with a cover film, which is removed before the insulating tape is installed.

This ensures that even relatively thick insulating layers can be stored and transported suitably in space-saving fashion, while at the same time they offer high insulating values and can be attached easily by adhesion to the substrate.

The insulating tape is preferably wound up into rolls for ease of handling and to save space.

In this arrangement, the bottom edges of adjacent segments of the insulating layer lie adjacent to each other, whereas the top edges are a certain distance apart, so that a wedge-spaced gap, expanding toward the top surface, is formed between the segments. In this way, it is easily possible to roll up even very thick insulating tapes with high insulating values and to store and transport them in the rolled-up state without impairing the material properties of the insulating tape.

To achieve high insulating values, the insulating layer according to preferred embodiments comprises mineral wool, a rigid polyurethane foam, a rigid polyethylene foam, a rigid polypropylene foam, pressboard, wood, styrofoam, or a hollow-chamber profile made of plastic or of some other material.

As the backing layer it is possible to use nonwovens, limp fabrics, limp films, or combinations of these.

In an advantageous embodiment, the backing layer has self-adhesive properties also on the side facing the insulating layer, as a result of which an adhesive bond between the backing layer and the insulating layer can be easily produced.

The incisions are advantageously arranged at intervals in the range of 1-15 cm, and preferably in the range of 1.5-7 cm. Through the choice of size range, insulating tapes with a thickness ranging from 3 mm up to several cm, and preferably with a thickness in the range between 5 mm and 7 cm, can be easily and very compactly stored and transported.

### DESCRIPTION OF THE DRAWINGS

Additional features and advantages of the present invention can be derived from the following description, which makes reference to the drawings.

FIG. 1 is a cross-sectional view of an insulating tape according to the invention in the partially rolled-up state and in the partially unrolled, functional state; and

FIG. 2 is a schematic diagram of a process for producing the insulating tape according to the invention.

### DETAILED DESCRIPTION OF A PREFERRED EMBODIMENT

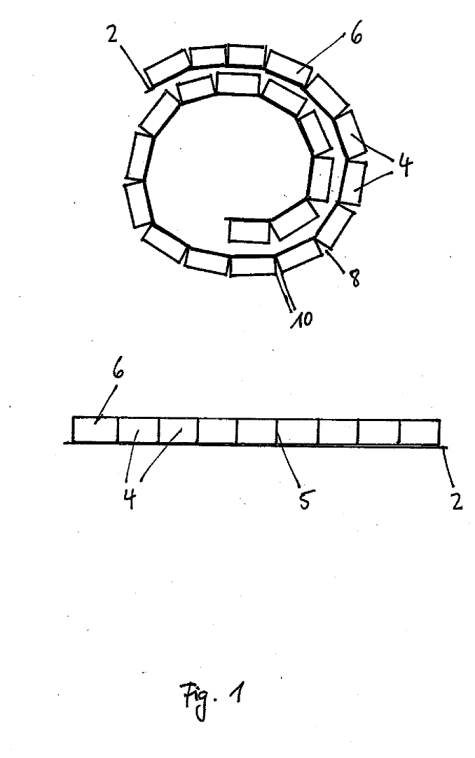

The insulating tape in FIG. 1 is shown in a partially rolled-up state and in a partially unrolled, functional state. The insulating tape has a backing layer 2, which can consist of, for example, a nonwoven, a limp textile material, or a limp film. The segments 4 of an insulating layer 6 are applied adhesively to backing layer 2, the segments having been separated from each other by incisions 5. Insulating layer 6 has a very high insulating value and consists of a rigid insulating material such as mineral wool, a rigid polyurethane foam, a rigid polyethylene foam, a rigid polypropylene foam, pressboard, wood, styrofoam, or a hollow-chamber profile of plastic or of some other material. Basically any rigid, that is, substantially nonflexing, material suitable for insulating purposes can be used.

Backing layer 2 preferably has a thickness between about 15 μm and 2 mm, and backing layer 2 is preferably provided with self-adhesive properties on the side facing segments 4 of insulating layer 6, as a result of which it becomes extremely easy to bond segments 4 to backing layer 2. In the case of certain other materials, there is also the possibility of thermally bonding the segments by welding or by the use of ultrasound. To simplify the installation of the insulating tape, the other side of backing layer 2 is preferably provided with self-adhesive properties. In this case, a cover film (not shown) is necessary, which is placed on top of the self-adhesive surface of backing layer 2. Alternatively, the top surface of insulating layer 6 can be coated with, for example, a siliconized film to serve as a covering, so that there is no need for a separate cover film on self-adhesive backing layer 2.

Segments 4 of insulating layer 6 have a thickness ranging from 3 mm to several cm, preferably in the range between 5 mm and 7 cm, and have a length in the approximate range of 1-15 cm, preferably in the range of 1.5-7 cm. Individual segments 4 and thus the insulating tape as a whole can have almost any width desired; the width will be chosen on the basis of the application in question. Typical widths of these insulating tapes are in the range of 3-20 cm.

Whereas the individual segments of insulating layer 6 lie adjacent to each other when in the straightened-out functional state, so that they form a continuous insulating layer 6, the division of insulating layer 6 into individual segments 4 in the rolled-up state of the insulating tape has the effect that adjacent segments 4 of insulating layer 6 butt up against each other at their bottom edges and spread apart from each other in the direction toward the top edges, so that a wedge-shaped gap 8 is formed, which expands in the direction toward the top surface.

Depending on the curvature of the insulating tape after it has been rolled up, these gaps 8 span a greater or lesser angle between the facing side surfaces 10 of two adjacent segments 4. It is thus possible, independently of the thickness of segments 4 of insulating layer 6 and without influencing the insulating properties, to store an inventive insulating tape and to transport it to the work site in a very space-saving manner. The shape of the roll is usually not completely round, because individual segments 4, once beyond a certain thickness or length, are almost completely rigid, and thus the roll of insulating tape assumes the form of a row of many straight sections, one next to the other, as can be seen in FIG. 1.

In the installed, straightened-out functional state, the insulating tape provides a superior insulating value, which corresponds to the insulating value of a continuous insulating layer.

It is also possible for the incisions 5 to have a certain width, so that individual segments 4, even in the functional state, can be a predetermined distance away from each other. Insulating layer 6 can be cut through completely, but it is also possible to leave thin webs of insulating layer 6 between individual segments 4, which, when the insulating tape is rolled up, either break or bend to the necessary extent. In the latter case, it would even be possible to omit backing layer 2.

The insulating tape can also have fire prevention properties.

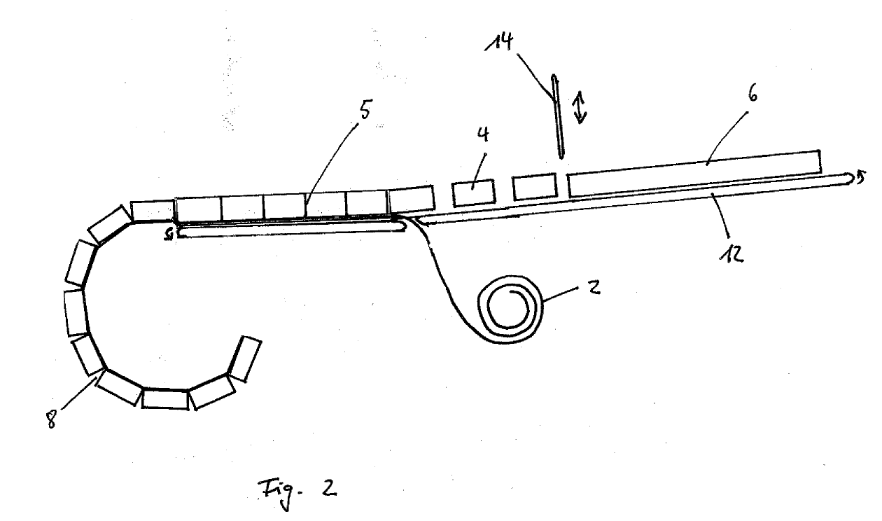

FIG. 2 shows, in schematic fashion, a possible production process for the insulating tape according to the invention. Insulating layer 6 is prepared as flat stock and moved forward on a conveyor belt 12. Insulating layer 6 can already have been cut into long strips of any desired width. Then insulating layer 6 is separated at predetermined intervals by means of at least one trim saw 14, as a result of which individual segments 4 of insulating layer 6 are formed. Several trim saws 14, arranged parallel to each other a certain distance apart, could also be used. forward movement of the conveyor belt 12 and the actuation of the trim saws preferably proceed at intervals.

Then the bottom surface of individual segments 4 of insulating layer 6 is provided with backing layer 2 and attached adhesively to it. Preferably backing layer 2 is provided with self-adhesive properties for this purpose. When backing layer 2 is applied, it is important that at least certain areas of individual segments 4 of insulating layer 6 rest precisely against each other. Then, if desired, individual segments 4 are pressed onto the backing layer by a pressing device. In this state, individual segments 4 are arranged directly adjacent to each other and in combination form a continuous insulating layer 6. The insulating tape thus obtained is then preferably wound up into a roll and thus acquires a form suitable for storage and transportation.

An insulating tape is thus created which not only offers superior insulating values but also the property that it can be stored and transported easily in a space-saving fashion.

1. An insulating tape comprising:
a backing layer, which has two opposite sides;
segments of an insulating layer of rigid insulation material, which are attached adhesively to the first side of the backing layer, wherein the segments of the insulating layer are separated from each other by incisions arranged at predetermined intervals and are connected to each other by the backing layer; and
the backing layer having a self-adhesive property on the second side.

2. The insulating tape according to claim 1 wherein the insulating tape is wound up into a roll.

3. The insulating tape according to claim 2 wherein adjacent segments of the insulating layer lie adjacent to each other at their bottom edges and proceed away from each other in the direction toward their top edges, so that a wedge-shaped gap, which expands toward the top surface, is formed.

4. The insulating tape according to claim 1 wherein the insulating layer comprises mineral wool, a rigid polyurethane foam, a rigid polyethylene foam, a rigid polypropylene foam, pressboard, wood, styrofoam, or a hollow-chamber profile of plastic or of some other material.

5. The insulating tape according to claim 1 wherein the backing layer comprises a nonwoven, a limp textile material, or a limp film.

6. The insulating tape according to claim 5 wherein the backing layer has self-adhesive properties on both sides.

7. The insulating tape according to claim 1 wherein the incisions in the insulating layer are arranged at intervals in the range of 1-15 cm, and preferably in the range of 1.5-7 cm.

8. The insulating tape according to claim 1 wherein the insulating layer has a thickness ranging from 3 mm to several cm, and preferably from 5 mm to 7 cm.

9. The insulating tape according to claim 5 wherein the backing layer has a thickness ranging from 15 μm to 2 mm.
